(19) United States
(12) Patent Application Publication
(10) Pub. No.: US 2006/0182358 A1
(43) Pub. Date: Aug. 17, 2006

(54) Coding apparatus, decoding apparatus, data file, coding method, decoding method, and programs thereof

(75) Inventors: Masanori Sekino, Kanagawa (JP); Shunichi Kimura, Kanagawa (JP); Yutaka Koshi, Kanagawa (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 11/203,094

(22) Filed: Aug. 15, 2005

(30) Foreign Application Priority Data
Nov. 5, 2004 (JP) 2004-321692

(51) Int. Cl. G06K 9/46

(52) U.S. Cl. 382/243

(57) ABSTRACT

A coding apparatus includes a shape coding section and a density coding section. The shape coding section codes shape information of an image element contained in an input image. The density coding section codes density information of the image element contained in the input image, with using a density dictionary including a binary pattern representing an image density and first identification information identifying the binary pattern in association with each other.

### BACKGROUND OF THE INVENTION

1. Field of the Invention

The invention relates to a coding apparatus that generates an image dictionary in which image patterns forming an input image and identification information of the image patterns are associated with each other, the coding apparatus applying the generated image dictionary to coding processing.

2. Description of the Related Art

When a halftone input image is binarized, each image element (object) contained in the input image becomes a binary image represented at quasi-gray scale by means of pulse-surface-area modulation. Halftone region coding of JBIG2 has been proposed as a coding system of such a binary image represented at quasi-gray scale.

FIG. 1 is a drawing to describe coding processing for a halftone region. FIG. 1A shows a binary image to be coded. FIG. 1B shows an image dictionary 700 generated in the halftone region coding processing. FIG. 1C shows code data and its decoded image 610 generated using the image dictionary 700.

As shown in FIG. 1A, a halftone image element (in this example, character image “A”) is made up of a plurality of halftone patterns responsive to the density values (gray-scale values) and is represented at quasi-gray scale. The size of each dot pattern corresponds to the density value (gray-scale value). In this example, the character image “A” has a uniform density and thus, the halftone patterns of the uniform size make up the character image “A.”

In the halftone region coding processing of JBIG2, the halftone patterns (binary) are registered in the image dictionary 700 (described later) in association with the density values and the binary image made up of the halftone patterns is coded.

As shown in FIG. 1B, if plural halftone patterns different in size exist in an input image 600, each halftone pattern is registered in the image dictionary 700 in association with index (density value). Each index is identification information for uniquely identifying the halftone pattern. In this example, each index is the density value (gray-scale value).

When the input image 600 is coded using the image dictionary 700, code data as shown in FIG. 1C is generated. The code data is made up of the density value of each region in the input image 600 (namely, index) and position information indicating a position where the density value exists (position on lattice).

The code data is decoded by referencing the image dictionary 700 to form the decoded image 610. Specifically, halftone patterns registered in the image dictionary 700 are selected based on the code data (density values), and the selected halftone patterns are placed in accordance with the code data (position information) to generate the decoded image 610.

FIG. 2 is a drawing to show a decoded image 610a when the input image 600 containing edges is coded by the halftone region coding processing.

As shown in FIG. 2, when the character image “A” having edges is coded by the halftone region coding processing, edge information of the character image “A” is lost in the decoded image 610a.

In JBIG2, text region coding has been proposed.

FIG. 3 is a drawing to describe the text region coding processing. FIG. 3A shows an image dictionary 700b generated for the input image 600 containing edges. FIG. 3B shows a decoded image 610b when the input image 600 is coded by the text region coding processing. FIG. 3C is a drawing to show halftone patterns of image elements of the same shape.

In the text region coding processing, typical image patterns appearing in the input image 600 are registered in the image dictionary 700b in association with the indices for identifying the respective image patterns. The input image is coded using the image dictionary 700b.

Specifically, as shown in FIG. 3A, in the text region coding processing, all halftone images contained in the input image 600 are registered in the image dictionary 700b. Each of the halftone patterns registered in the image dictionary 700b is given index. The input image 600 is coded using the image dictionary 700b. That is, each halftone image existing in the edge region of the input image 600 (halftone image having edge information) is registered in the image dictionary 700b as a halftone pattern and thus, the decoded image 610b with the edge information retained is provided.

However, the halftone images existing in the edge regions have various shapes and thus, number of entries of the image dictionary 700b increases. Therefore, it becomes difficult to realize a high compression rate. Particularly, as shown in FIG. 3C, even if plural image elements having the same shape (in the example, character image “A”) exist in the same input image, if the image elements differ in screen processing phase, the halftone images forming the image elements also differ from each other and realizing a high compression rate is hindered.

In JBIG2, generic region coding has been proposed.

The generic region coding is a system of coding an input image without generating the image dictionary 700 as described above. More specifically, in the generic region coding, the input image is coded using statistics of local arrangement of pixels (for example, context). Therefore, to apply the generic region coding for coding an input image containing edge regions, the halftone patterns of the edge regions have various shapes as shown in FIG. 3C and thus, a high compression rate cannot be expected.

### SUMMARY OF THE INVENTION

The invention has been made in view of the background set forth above, and provides a coding apparatus for coding a binary image with image quality degradation suppressed.

[Coding Apparatus]

According to one embodiment of the invention, a coding apparatus includes a shape coding section and a density coding section. The shape coding section codes shape information of an image element contained in an input image. The density coding section codes density information of the image element contained in the input image, with using a density dictionary including a binary pattern representing an image density and first identification information identifying the binary pattern in association with each other.

The shape coding section may include a shape pattern selection section, a shape dictionary generation section, a pattern extraction section, and a shape code output section. The shape pattern selection section selects a shape of an image element appearing predetermined number of times or more in the input image, as a shape pattern. The shape dictionary generation section generates a shape dictionary including the shape pattern selected by the shape pattern selection section and second identification information identifying the shape pattern in association with each other. The pattern extraction section extracts the image element corresponding to the shape pattern from the input image with using the shape dictionary generated by the shape dictionary generation section. The shape code output section outputs the second identification information of the shape pattern corresponding to the extracted image element and position information indicating an appearance position of the extracted image element as a part of code data of the image element extracted by the pattern extraction section.

Also, the density dictionary may include binary patterns corresponding to image densities and colors in association with the first identification information identifying the binary patterns. The density coding section may select the second identification information corresponding to the image density and color from the density dictionary, as the density information of the image element of each color component image making up the input image.

Also, the density coding section may include a binary pattern selection section, a density dictionary generation section, and a density code output section. The binary pattern selection section selects a binary pattern appearing in the input image. The density dictionary generation section generates the density dictionary including the binary pattern selected by the binary pattern selection section and the first identification information identifying the binary pattern in association with each other. The density code output section outputs the first identification information of the binary pattern corresponding to the image density and position information of the image density as code data corresponding to the density information contained in the input image with using the density dictionary generated by the density dictionary generation section.

According to one embodiment of the invention, a coding apparatus includes a shape coding section and a density coding section. The shape coding section codes shape information of an image element contained in an input image with using a shape dictionary including a shape pattern indicating a typical shape contained in the input image and identification information identifying the shape pattern in association with each other. The density coding section codes density information of the image element contained in the input image.

According to one embodiment of the invention, a coding apparatus includes a shape coding section and a pattern coding section. The shape coding section codes shape information of an image element contained in an input image. The pattern coding section codes pattern information of the image element contained in the input image with using a pattern dictionary including a binary pattern representing a pattern of the image element and identification information identifying the binary pattern in association with each other.

[Decoding Apparatus]

According to one embodiment of the invention, a decoding apparatus includes a shape decoding section, a binary pattern selection section, and a data generation section. The shape decoding section decodes shape information of an image element contained in an input image based on code data. The binary pattern selection section selects a binary pattern corresponding to an image density of the image element with using a density dictionary including a binary pattern representing the image density and identification information identifying the binary pattern in association with each other. The data generation section generates image data of the image element contained in the input image with using the shape information provided by the shape decoding section and the binary pattern selected by the binary pattern selection section.

According to one embodiment of the invention, a decoding apparatus includes a shape pattern selection section, a density decoding section, and a data generation section. The shape pattern selection section selects a shape pattern corresponding to an image element contained in an input image with using a shape dictionary including a shape pattern indicating a typical shape contained in the input image and identification information identifying the shape pattern in association with each other. The density decoding section decodes density information of the image element contained in the input image based on code data. The data generation section generates image data of the image element contained in the input image with using the shape pattern selected by the shape pattern selection section and the density information provided by the density decoding section.

According to one embodiment of the invention, a decoding apparatus includes a shape decoding section, a binary pattern selection section, and a data generation section. The shape decoding section decodes shape information of an image element contained in an input image based on code data. The binary pattern selection section selects a binary pattern corresponding to a pattern of the image element with using a pattern dictionary including a binary pattern representing a pattern of image element and identification information identifying the binary pattern in association with each other. The data generation section generates image data of the image element contained in the input image with using the shape information provided by the shape decoding section and the binary pattern selected by the binary pattern selection section.

[Data File]

According to one embodiment of the invention, a data file includes a density dictionary in which binary patterns representing image density and identification information identifying the binary patterns are registered in association with each other; the identification information of the binary pattern corresponding to an image density of an image element contained in an input image; position information indicating an appearance position of the image element; and shape information indicating a shape of the image element.

According to one embodiment of the invention, a data file includes a pattern dictionary in which binary patterns representing patterns and identification information identifying the binary patterns are registered in association with each other; the identification information of the binary pattern corresponding to a pattern of an image element contained in an input image; position information indicating a appearance position of the image element; and shape information indicating a shape of the image element.

[Coding Method]

According to one embodiment of the invention, a coding method includes coding shape information of an image element contained in an input image; and coding density information of the image element contained in the input image with using a density dictionary including a binary pattern representing an image density and identification information identifying the binary pattern in association with each other.

[Decoding Method]

According to one embodiment of the invention, a decoding method includes decoding shape information of an image element contained in an input image based on code data; selecting a binary pattern corresponding to the code data from a density dictionary including a binary pattern representing an image density and identification information identifying the binary pattern in association with each other; and generating image data of the image element contained in the input image with using the provided shape information and the selected binary pattern.

The coding apparatus according to embodiments of the invention can generate code data of a binary image with high image quality and at a high compression rate.

### BRIEF DESCRIPTION OF THE DRAWINGS

Embodiments of the invention will be described in detail based on the following drawings, wherein:

FIG. 1 is a drawing to describe halftone region coding processing; FIG. 1A shows a binary image to be coded, FIG. 1B shows an image dictionary 700 generated in halftone-region coding processing, and FIG. 1C shows code data and its decoded image 610 generated using the image dictionary 700;

FIG. 2 is a drawing to show a decoded image 610a when an input image 600 containing edges is coded by the halftone region coding processing;

FIG. 3 is a drawing to describe text region coding processing; FIG. 3A shows an image dictionary 700b generated for the input image 600 containing edges, FIG. 3B shows a decoded image 610b when the input image 600 is coded by the text region coding processing, and FIG. 3C is a drawing to show the halftone patterns of image elements of the same shape;

FIG. 4 is a drawing to describe an outline of coding processing and decoding processing in an embodiment of the invention;

FIG. 5 is a drawing to show the hardware configuration of an image processing apparatus 2 incorporating a coding method and a decoding method according to the invention centering on a controller 20;

FIG. 6 is a block diagram to show the function configuration of a coding program 4 for implementing the coding method according to the invention, executed by the controller 20 (FIG. 5);

FIG. 7 is a drawing to describe density information coding processing; FIG. 7A shows the input image 600, FIG. 7B shows a density dictionary 710 corresponding to the input image 600, and FIG. 7C shows the code data of the density information of the input image 600;

FIG. 8 is a drawing to describe shape information coding processing; FIG. 8A shows the input image 600, FIG. 8B shows a shape dictionary 720 corresponding to the input image 600, and FIG. 8C shows the code data of the shape information of the input image 600;

FIG. 9 is a drawing to show code data 900 generated by the coding program 4 (FIG. 6);

FIG. 10 is a flowchart to show coding processing (S10) of the coding program 4;

FIG. 11 is a block diagram to show the function configuration of a decoding program 5 for implementing the decoding method according to the invention, executed by the controller 20 (FIG. 5);

FIG. 12 is a flowchart to show decoding processing (S20) of the decoding program 5; and

FIG. 13 is a drawing to describe coding processing and decoding processing for separating image elements into shape information and pattern information and coding the shape information and the pattern information separately.

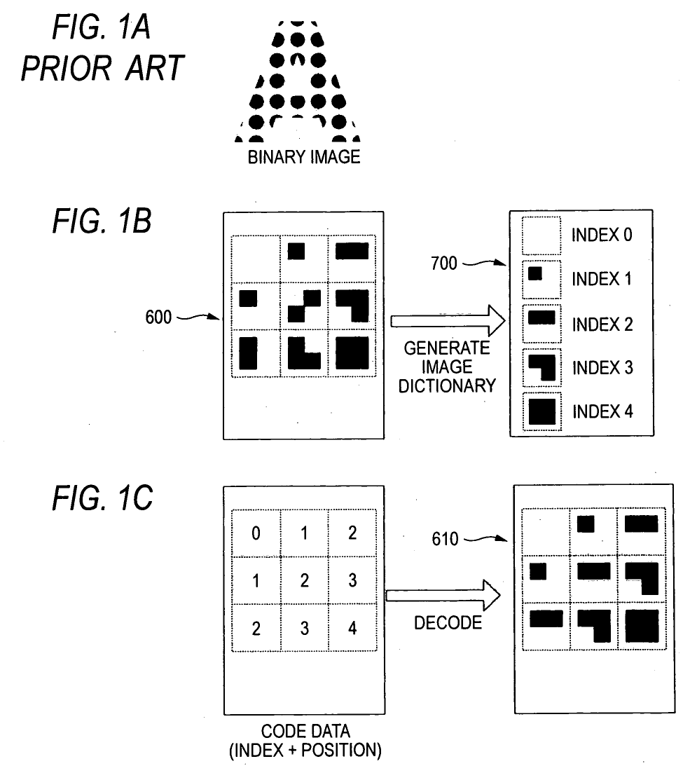

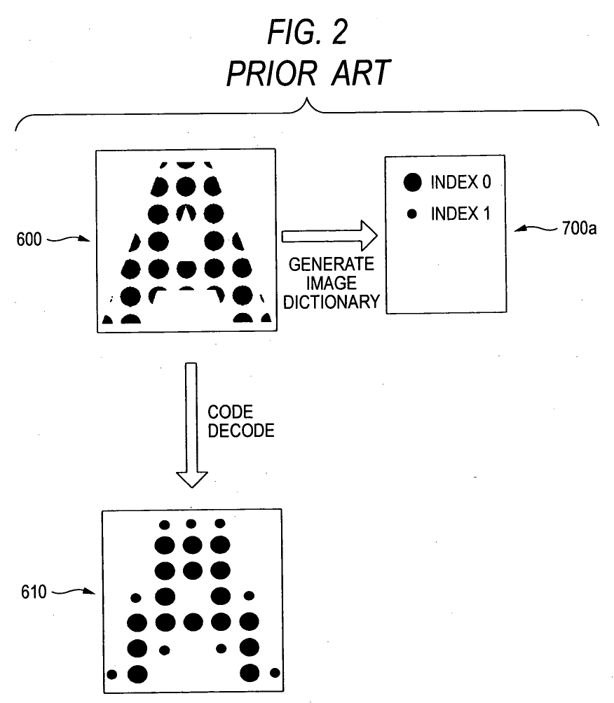

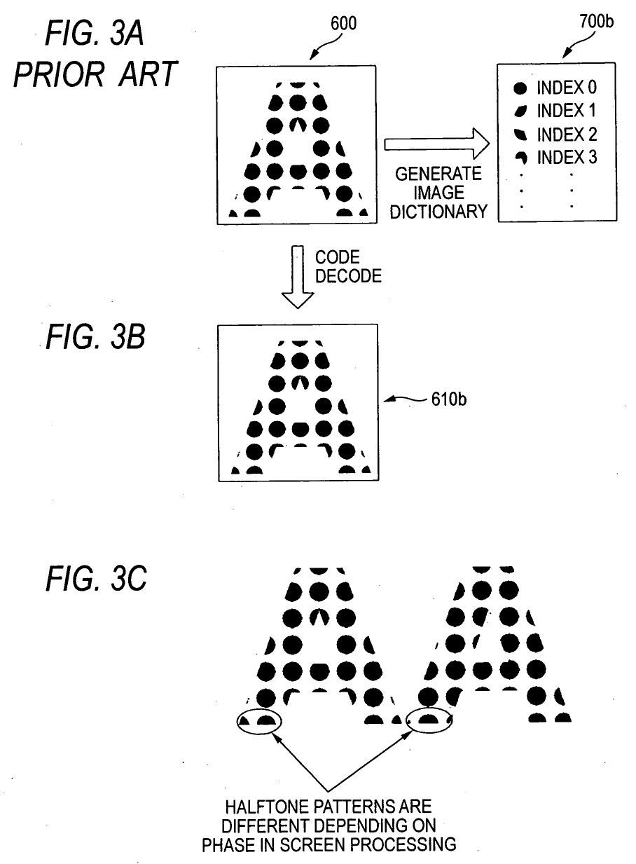

### DETAILED DESCRIPTION OF THE PREFERRED EMBODIMENTS

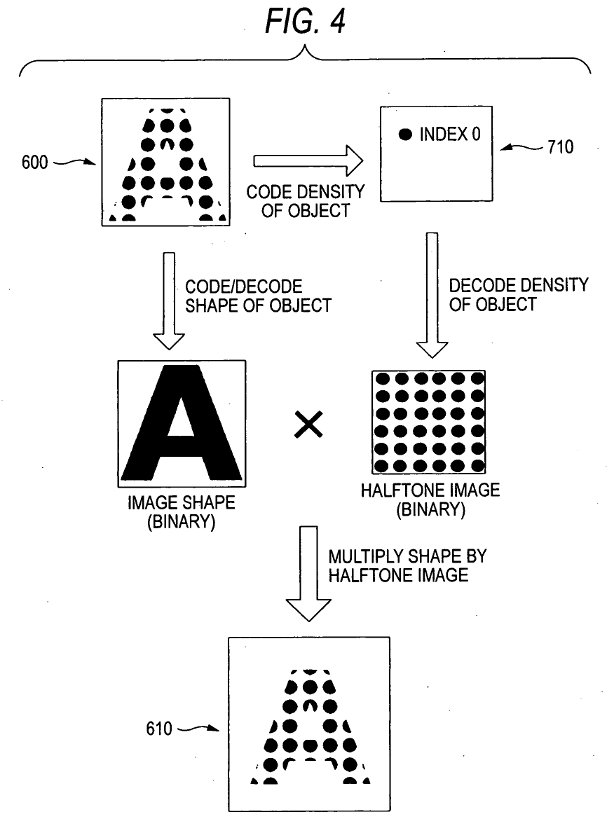

FIG. 4 is a drawing to describe an outline of coding processing and decoding processing in an embodiment of the present invention.

The image processing apparatus 2 according to this embodiment registers halftone patterns corresponding to the density value of an image element (in the example, character image “A”) contained in an input image 600 in a density dictionary 710 in association with index (for example, density value). The image processing apparatus 2 adopts the index of the halftone pattern corresponding to the density value and position information indicating a region where the density value exists, as code data of the density information.

The image processing apparatus 2 codes the shape of the image element (character image “A”) contained in the input image 600 by performing the text region coding processing.

When decoding the code data of the image element (density information and shape information), the image processing apparatus 2 according to this embodiment generates an image shape indicting the shape of the image element based on the code data of the shape information and places the halftone patterns registered in the density dictionary 710 based on the code data of the density information to generate a halftone image. The image processing apparatus applies multiplication operation to the generated image shape and the halftone image, thereby generating a decoded image 610.

Thus, the image processing apparatus 2 separates and codes the shape information and the density information, thereby efficiently coding the binary image made up of halftone patterns while the edge information of the image element (character image “A”) being retained.

If image elements of the same shaper appear repeatedly in the same input image, the shape information is common to the image elements and therefore a higher compression rate can be expected.

The image processing apparatus 2 according to this embodiment will be discussed more specifically.

[Hardware Configuration]

Next, the hardware configuration of the image processing apparatus 2 will be discussed.

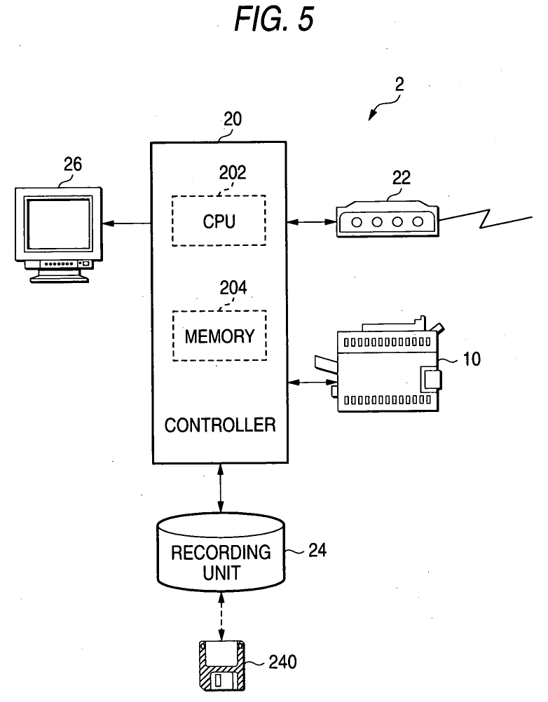

FIG. 5 is a drawing to show the hardware configuration of the image processing apparatus 2 employing a coding method and a decoding method according to this embodiment of the invention, centering on a controller 20.

As shown in FIG. 5, the image processing apparatus 2 includes the controller 20 having a CPU 202 and memory 204; a communication unit 22, a recording unit 24 such as an HDD or CD unit; and a user interface unit (UI unit) 26 including an LCD (liquid crystal display) or a CRT display, a keyboard, and a touch panel.

The image processing apparatus 2 may be a general-purpose computer in which a coding program 4 and a decoding program 5 (described later) are installed as a part of a printer driver. The image processing apparatus 2 acquires image data through the communication unit 22 and the recording unit 24; codes or decodes the acquired image data; and then, transmits the image data to a printer 10. The image processing apparatus 2 may acquire image data optically read by a scanner function of the printer 10 and code the acquired image data.

[Coding Program]

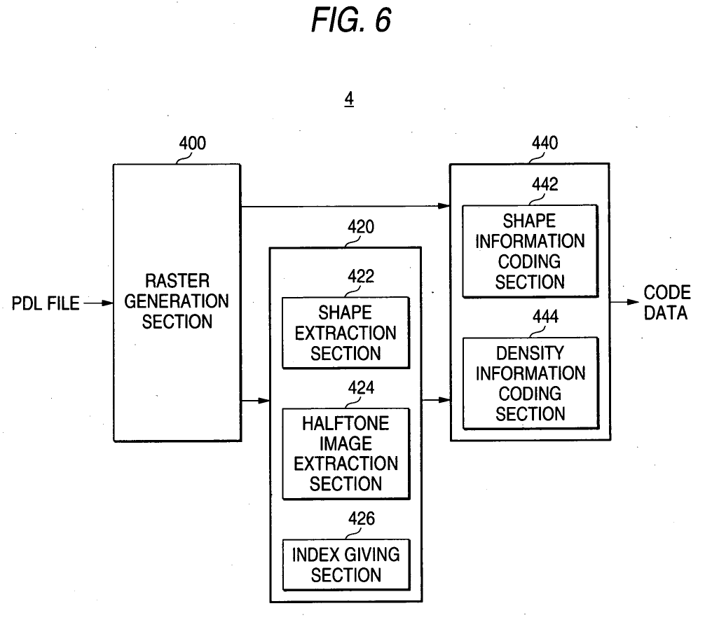

FIG. 6 is a block diagram to show the function configuration of the coding program 4 for implementing the coding method according to this embodiment of the invention, executed by the controller 20 (FIG. 5).

As shown in FIG. 6, the coding program 4 has a raster generation section 400, an image dictionary generation section 420, and a code generation section 440. The image dictionary generation section 420 includes a shape extraction section 422, a halftone image extraction section 424, and an index giving section 426. The code generation section 440 includes a shape information coding section 442 and a density information coding section 444.

All or some functions of the coding program 4 may be implemented as an ASIC installed in the printer 10.

In the coding program 4, the raster generation section 400 acquires image data (input image 600) in a PDL (Page Description Language) format obtained through the communication unit 22 and/or the recording unit 24, converts the acquired image data of the input image 600 into raster data of each color component (each color component image), performs screen processing for the raster data, and outputs the data to the image dictionary generation section 420 and the code generation section 440. The raster generation section 400 determines the shape information and position information of each image element (object) contained in the input image 600 based on the image data in the PDL format and outputs the determined shape information and position information of the image element to the image dictionary generation section 420.

If an input image 600, which has been rasterized in advance, such as image data optically read through a scanner is input, the coding program 4 may determine the shape information and the position information of each image element by means of pattern matching.

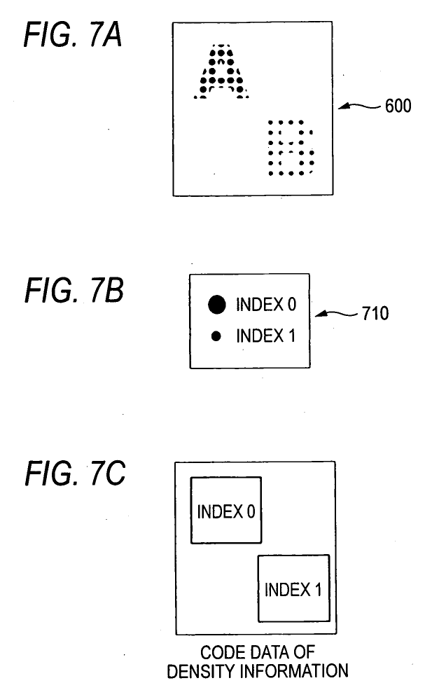

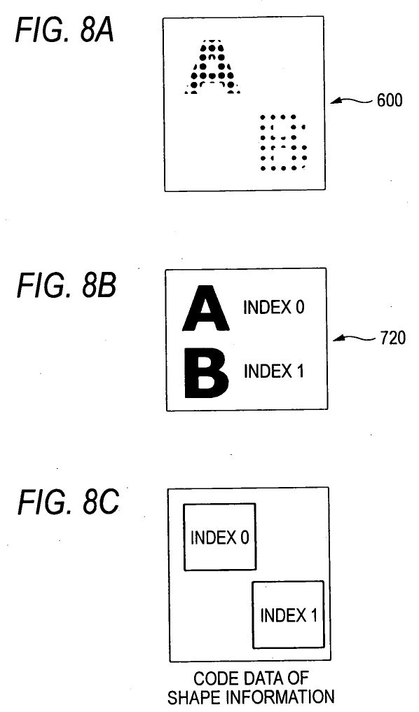

The image dictionary generation section 420 generates the density dictionary 710 (FIGS. 4 and 7) applied to coding processing for the density information and a shape dictionary 720 (FIG. 8) applied to coding processing for the shape information, based on the input image 600, the shape information of the image element, and the position information of the image element input from the raster generation section 400. The image dictionary generation section 420 outputs the generated density dictionary 710 and the generated shape dictionary 720 to the code generation section 440.

More specifically, the shape extraction section 422 extracts the shape of the image element appearing in each color component image as a shape pattern, based on the shape information of the image element input from the raster generation section 400. The shape pattern of this embodiment contains the shape (for example, edge information) and does not contain density information or color information.

The halftone image extraction section 424 extracts the halftone pattern appearing in each color component image, based on the input image (binary image subjected to screen processing) input from the raster generation section 400. The halftone pattern extracted by the halftone image extraction section 424 is a halftone pattern corresponding to the density value of the image element and does not include any halftone pattern existing in the edge regions.

The index giving section 426 gives pattern identification indices to the shape patterns extracted by the shape extraction section 422 and the halftone patterns extracted by the halftone image extraction section 424, respectively. That is, the index giving section 426 generates the shape dictionary 720 (described later with reference to FIG. 8) with the indices associated with the shape patterns, and generates the density dictionary 710 (FIGS. 4 and 7) with indices (density value) associated with the halftone patterns. The indices are, for example, identification information separately generated for each input image, and may be serial number given to each image pattern in order in which image patterns are extracted from the input image.

The code generation section 440 codes the image elements contained in the input image 600 based on the density dictionary 710 and the shape dictionary 720 input from the image dictionary generation section 420, and outputs the code data of the coded image elements and the image dictionaries (the density dictionary 710 and the shape dictionary 720) to the recording unit 24 (FIG. 5) or the printer 10 (FIG. 5).

More specifically, the shape information coding section 442 makes a comparison between the shape patterns registered in the shape dictionary 720 and a partial image contained in each color component image, and replaces the data of the partial image, which matches or is similar to any image pattern, with the index corresponding to the shape pattern and the position information of the partial image. Further, the shape information coding section 442 may code the index and the position information, with which the partial image is replaced, and the shape dictionary 720 by means of entropy coding (Huffman coding, arithmetic coding, LZ coding, or the like).

The density information coding section 444 codes the density information of the partial image contained in each color component image, based on the halftone pattern (density value) and the indices registered in the density dictionary 710. For example, as the code data of the density information of each partial image, the density information coding section 444 outputs the position information indicating a region of the partial image and the density value of the partial image (namely, index) in association with each other.

FIG. 7 is a drawing to describe density information coding processing. FIG. 7A shows the input image 600. FIG. 7B shows the density dictionary 710 corresponding to this input image 600. FIG. 7C shows the code data of the density information of the input image 600.

As shown in FIG. 7A, the input image 600 may contain plural halftone density values. In the example, the halftone density values of character images “A” and “B” are different from each other. In such a case, the halftone image extraction section 424 (FIG. 6) extracts dot patterns corresponding to the respective halftone density values. That is, if dot patterns different in size (except halftone patterns in edge regions) exist in the input image 600, the halftone image extraction section 424 extracts the respective halftone patterns and registers the respective halftone patterns in the density dictionary 710 as shown in FIG. 7B. Since the halftone pattern shape may vary from one color component image to another, if halftone patterns different in shape (except halftone patterns in edge regions) exist in the input image 600 (including plural color component images), the halftone image extraction section 424 extracts the respective halftone patterns and registers the respective halftone patterns in the density dictionary 710.

The index giving section 426 (FIG. 6) gives indices (identification information) for identifying those halftone patterns to the halftone patterns extracted by the halftone image extraction section 424 to generate the density dictionary 710 as shown in FIG. 7B.

The density information coding section 444 (FIG. 6) codes the density information of the input image 600 based on the density dictionary 710 generated as described above. Specifically, the density information coding section 444 determines a region having the halftone pattern registered in the density dictionary 710 (namely, the density value) and adopts a pair of the position information of the determined region and the index corresponding to the halftone pattern of the region as the code data of the density information, as shown in FIG. 7C.

FIG. 8 is a drawing to describe shape information coding processing. FIG. 8A shows the input image 600. FIG. 8B shows the shape dictionary 720 corresponding to this input image 600. FIG. 8C shows the code data of the shape information of the input image 600.

As shown in FIG. 8A, the input image 600 may contain plural image elements different in shape. In this example, character images “A” and “B” differ in shape. In such a case, the shape extraction section 422 (FIG. 6) extracts shape patterns indicating the respective image shapes. That is, if image elements different in contour shape exist in the input image 600, the shape extraction section 422 extracts shapes of the respective image elements as shape patterns and registers the respective shape patterns in the shape dictionary 720 as shown in FIG. 8B. An image shape common among color component images making up a color image may exist (for example, if the character image “A” is a color image, a C (cyan) character image “A,” an M (magenta) character image “A,” a Y (yellow) character image “A,” and a K (black) character image “A” may exist). The shape extraction section 422 registers the image shape common among the color component images in the shape dictionary 720 as a single shape pattern.

The index giving section 426 (FIG. 6) gives index (identification information) for identifying the shape pattern to each of the shape patterns (“A” and “B”) extracted by the shape extraction section 422 to generate the shape dictionary 720 as shown in FIG. 8B.

The shape information coding section 442 (FIG. 6) codes the shape information of the input image based on the shape dictionary 720 generated as described above. Specifically, if the shape information coding section 442 finds in the input image 600 an image element having a shape roughly matching the shape pattern registered in the shape dictionary 720, the shape information coding section 442 adopts a pair of the position information indicating a region of the image element and the index of the shape pattern matching the shape of the image element as the code data of the shape information, as shown in FIG. 8C.

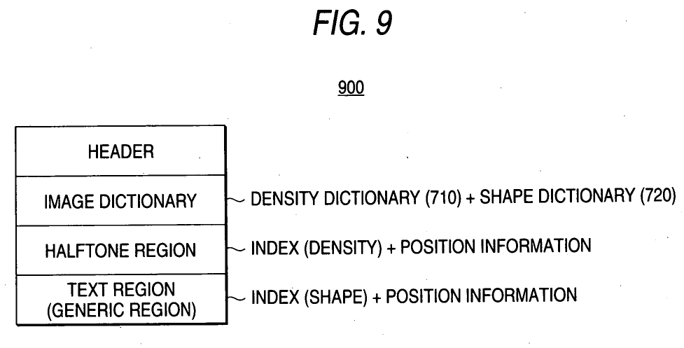

FIG. 9 is a drawing to show code data 900 generated by the coding program 4 (FIG. 6).

As shown in FIG. 9, the code data 900 includes a header containing attribute information of the data, an image dictionary having the density dictionary 710 and the shape dictionary 720, halftone region code corresponding to the code data of the density information, and text region code (or generic region code) corresponding to the code data of the shape information.

In the density dictionary 710, the halftone patterns contained in an input image and the indices (density value) for identifying the halftone patterns are registered in association with each other.

In the shape dictionary 720, the shape patterns corresponding to the contours of the respective image elements contained in an input image and indices for identifying the shape patterns are registered in association with each other.

The halftone region code contains a pair of the index corresponding to each halftone pattern contained in the input image (namely, the density value) and the position information indicating an area where the halftone pattern (density value) exists.

The text region code (or generic region code) contains a pair of the index of the shape pattern corresponding to the shape of each image element contained in the input image and the position information indicating a position where the image element exists.

[Coding Operation]

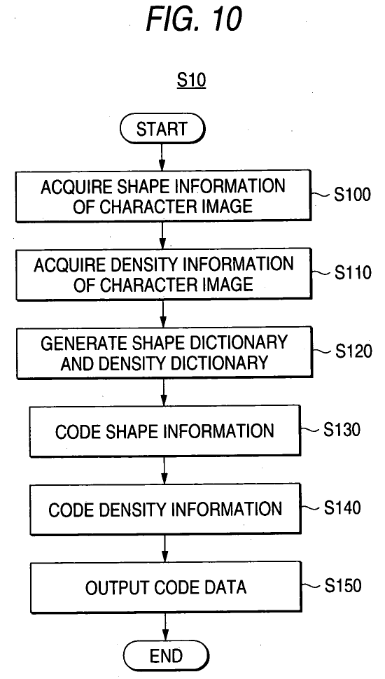

FIG. 10 is a flowchart to show the coding processing (S10) of the coding program 4. In this embodiment, the case where an input image containing a character image is coded will be discussed as a specific example.

As shown in FIG. 10, at step 100 (S100), when a PDL file is input as an input image 600, the raster generation section 400 (FIG. 6) determines shape information of each character image contained in the input image 600 and position information of the character image, based on the input PDL file. Then, the raster generating section 400 outputs the determined shape information and position information of the character image to the image dictionary generation section 420. The shape extraction section 422 of the image dictionary generation section 420 determines a shape pattern corresponding to contours of the character image existing in the input image 600 (plural color component images), based on the shape information and position information of the character image input from the raster generation section 400. The shape extraction section 422 of this embodiment determines the shape pattern using the shape information, which has been determined on the basis of the PDL file. However, the invention is not limited thereto. For example, a rasterized multi-valued image may be simply binarized on the basis of a predetermined threshold value, thereby determining a shape pattern.

The raster generation section 400 converts the image data of the input image 600 into raster data of each color component, applies the screen processing to the raster data and then, outputs the data to the image dictionary generation section 420 and the code generation section 440.

At step 110 (S110), the halftone image extraction section 424 (FIG. 6) extracts halftone patterns from the raster data (binary image) of the input image input from the raster generation section 400. More specifically, the halftone image extraction section 424 eliminates the halftone patterns in edge regions from the raster data of plural color component images (subjected to the screen processing), and selects the halftone patterns different in shape or size from the remaining halftone patterns.

At step 120 (S120), the index giving section 426 (FIG. 6) gives index for identifying the shape pattern to each of the shape patterns extracted by the shape extraction section 422, thereby generating the shape dictionary 720 (FIG. 8).

The index giving section 426 also gives index for identifying the halftone pattern to each of the halftone patterns extracted by the halftone image extraction section 424, thereby generating the density dictionary 710 (FIG. 7).

The generated shape dictionary 720 is input to the shape information coding section 442, and the generated density dictionary 710 is input to the density information coding section 444.

At step 130 (S130), the shape information coding section 442 (FIG. 6) makes a comparison between the shape patterns registered in the shape dictionary 720 and the character images (image elements) contained in each color component image to output the index corresponding to the shape pattern and the position information of the character image as the shape information of the character image, whose shapes matches or is similar to any image pattern.

At step 140 (S140), the density information coding section 444 (FIG. 6) determines the existence regions of the density values corresponding to the halftone patterns registered in the density dictionary 710 and outputs the position information indicating the existence region of each density value and the index corresponding to each density value as the density information.

At step 150 (S150), the code generation section 440 (FIG. 6) generates Huffman code, etc., corresponding to the shape information output from the shape information coding section 442 (index and position information corresponding to shape pattern), the density information output from the density information coding section 444 (index and position information corresponding to density value), the shape dictionary 720, and the density dictionary 710, and outputs the generated code data as the code data of the shape information, density information, shape dictionary 720 and density dictionary 710.

[Decoding Program]

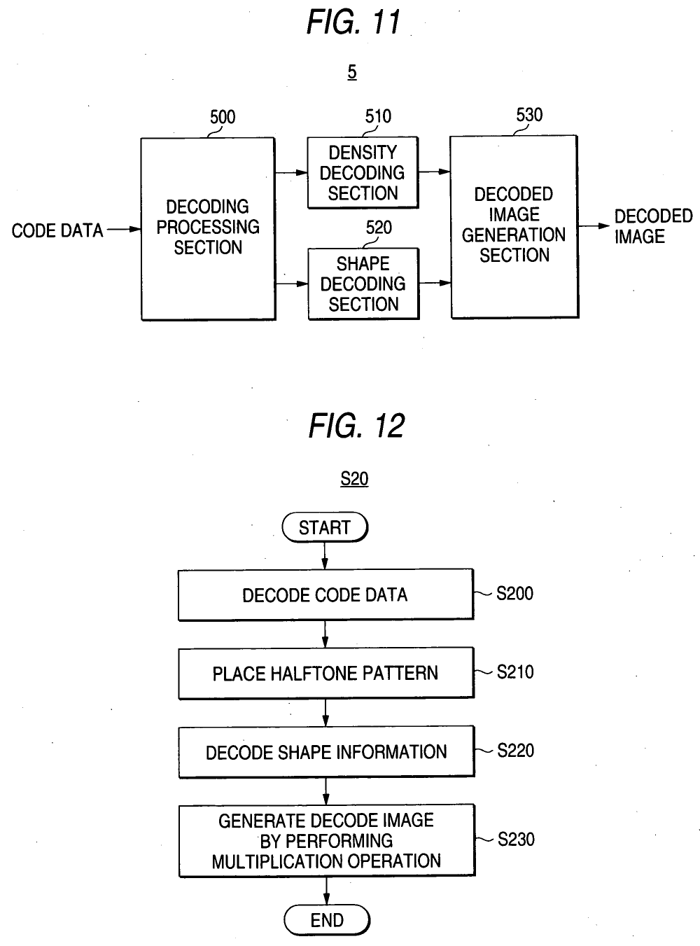

FIG. 11 is a block diagram to show the function configuration of the decoding program 5 for implementing the decoding method according to this embodiment of the invention, executed by the controller 20 (FIG. 5).

As shown in FIG. 11, the decoding program 5 has a decoding processing section 500, a density decoding section 510, a shape decoding section 520, and a decoded image generation section 530.

All or some functions of the decoding program 5 may be implemented as an ASIC, etc., installed in the printer 10.

In the decoding program 5, the decoding processing section 500 decodes input code data 900 (FIG. 9) into a set of index and position information, and image dictionary (density dictionary 710 and shape dictionary 720). The decoding processing section 500 outputs index of density information and position information of the density information (namely, text region code or generic region code) and the density dictionary 710 to the density decoding section 510. Also, the decoding processing section 500 outputs a set of index of shape information and position information of the shape information (namely, halftone region code) and the shape dictionary 720 to the shape decoding section 520.

The density decoding section 510 decodes the density information of the input image based on the index of the density information, the position information of the density information, and the density dictionary 710, which are input from the decoding processing section 500. More specifically, the density decoding section 510 places halftone patterns registered in the density dictionary 710 in accordance with the index of the density information and the position information of the density information, which are input from the decoding processing section 500, to generate a halftone image as shown in FIG. 4.

The shape decoding section 520 decodes the shape information of image elements contained in the input image based on the index of the shape information, the position information of the shape information, and the shape dictionary 720, which are input from the decoding processing section 500. More specifically, the shape decoding section 520 places shape patterns registered in the shape dictionary 720 in accordance with the index of the shape information and the position information of the shape information, which are input from the decoding processing section 500, to generate an image shape as shown in FIG. 4.

The decoded image generation section 530 decodes the code data of the input image 600 based on the density information provided by the density decoding section 510 and the shape information provided by the shape decoding section 520 to generate the decoded image 610. More specifically, the decoded image generation section 530 performs join operation (for example, multiplication operation) on the halftone image generated by the density decoding section 510 (halftone patterns placed in accordance with the index and position information) and the image shape generated by the shape decoding section 520 (shape patterns placed in accordance with the index and position information), thereby generating the decoded image 610 (FIG. 4).

[Decoding Operation]

FIG. 12 is a flowchart to show decoding processing (S20) of the decoding program 5.

As shown in FIG. 12, at step 200 (S200), the decoding processing section 500 (FIG. 11) decodes the input code data 900 (FIG. 9) into the halftone region code (a set of index of density information and position information of the density information), the text region code (set of index of shape information and position information of the shape information), and the image dictionary (density dictionary 710 and shape dictionary 720). Then, the decoding processing section 500 outputs the index of the density information, the position information of the density information, and the density dictionary 710 to the density decoding section 510. Also, the decoding processing section 500 outputs the index of the shape information, the position information of the shape information, and the shape dictionary 720 to the shape decoding section 520.

At step 210 (S210), the density decoding section 510 extracts the halftone pattern corresponding to the index from the density dictionary 710 based on the index of the density information and the position information of the density information, which are input from the decoding processing section 500. Then, the density decoding section 510 places the extracted halftone pattern in the region indicated by the position information. The image provided by placing the halftone patterns is input to the decoded image generation section 530 as the halftone image (FIG. 4).

At step 220 (S220), the shape decoding section 520 extracts the shape pattern corresponding to the index from the shape dictionary 720 based on the index of the shape information and the position information of the shape information, which are input from the decoding processing section 500. Then, the shape decoding section 520 places the extracted shape pattern in the region indicated by the position information. The image provided by placing the shape patterns is input to the decoded image generation section 530 as the image shape (FIG. 4).

At step 230 (S230), the decoded image generation section 530 performs multiplication operation on the halftone image generated by the density decoding section 510 (halftone patterns placed in accordance with the index of the density information and the position information of the density information) and the image shape generated by the shape decoding section 520 (shape patterns placed in accordance with the index of the shape information and the position information of the shape information), thereby generating the decoded image 610 (FIG. 4).

As described above, the image processing apparatus 2 according to this embodiment separates image elements making up an input image into shape information and density information, and codes the shape information and the density information separately, whereby the image processing apparatus 2 can efficiently code a binary image made up of halftone patterns while the image element edge information is maintained.

The image processing apparatus 2 can reduce redundancy of the shape information and redundancy of the density information separately, so that a higher compression rate can be expected.

In this embodiment, the case where plural intermediate density values exist in one input image 600 has been described as a specific example as shown in FIG. 7 and thus the position information corresponding to the density value needs to be a part of the density information. However, if only one intermediate density value exists in one input image 600, the position information corresponding to the density value is not required.

[Modifications]

The image processing apparatus 2 according to the aforementioned embodiment separates image elements contained in an input image into shape information and density information, and codes the shape information and the density information separately as shown in FIG. 4. However, the invention is not limited thereto. For example, image elements contained in an input image may be separated into shape information and pattern information, and the shape information and the pattern information may be coded separately.

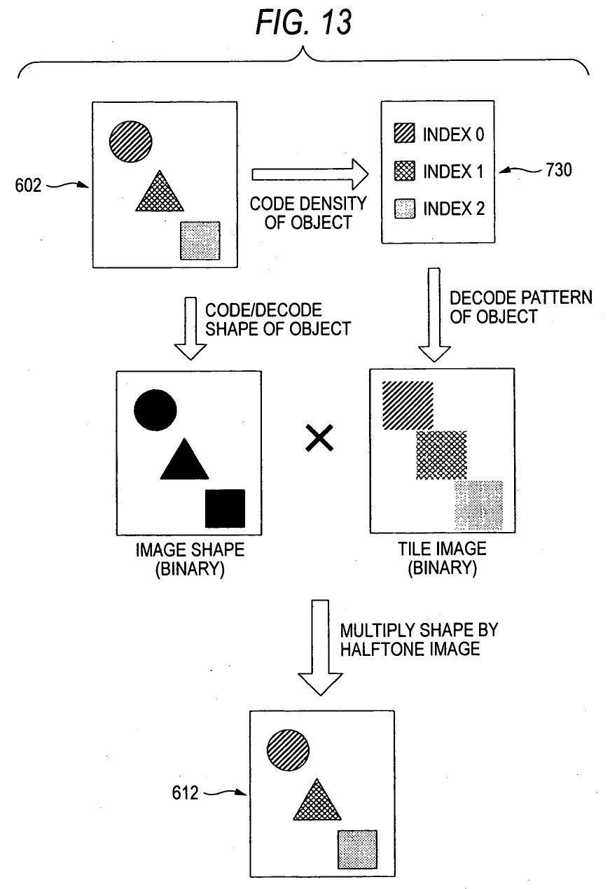

FIG. 13 is a drawing to describe coding processing and decoding processing for separating image elements into shape information and pattern information and coding the shape information and the pattern information separately.

As shown in FIG. 13, plural image elements contained in an input image 602 have different patterns.

The image processing apparatus 2 according to a modified embodiment generates a pattern dictionary 730 in accordance with patterns of the image elements contained in the input image 602 (in the example, a circle, an equilateral triangle, and a square) as shown in FIG. 13. Tile patterns forming the patterns of the image elements and index for identifying the tile pattern are registered in the pattern dictionary 730 in association with each other. The tile pattern is a unit image forming a part of a pattern. In other words, a pattern is formed by arranging plural tile patterns.

The image processing apparatus 2 according to the modified embodiment adopts the index of the tile pattern registered in the pattern dictionary 730 and the position information indicating a region where the tile pattern exists, as code data of the pattern information.

The image processing apparatus 2 according to the modified embodiment codes the shapes of the image elements contained in the input image 602 by performing the text region coding processing as with the case shown in FIG. 4.

When decoding the code data of the image elements (pattern information and shape information), the image processing apparatus 2 according to the modified embodiment generates image shapes indicating shapes of the image elements based on the code data of the shape information, places the tile patterns registered in the pattern dictionary 730 to generate each tile image, and performs multiplication operation on the generated image shapes and the generated tile images, thereby generating a decode image 612.

Thus, the image processing apparatus 2 according to the modified embodiment separates image elements into shape information and pattern information and codes the shape information and the pattern information separately, whereby the image processing apparatus 2 can reduce redundancy of the shape information and redundancy of the pattern information independently and can accomplish a high compression rate.

What is claimed is:

1. A coding apparatus comprising:
a shape coding section that codes shape information of an image element contained in an input image; and
a density coding section that codes density information of the image element contained in the input image, with using a density dictionary including a binary pattern representing an image density and first identification information identifying the binary pattern in association with each other.

2. The coding apparatus according to claim 1, wherein:
the shape coding section comprises:
a shape pattern selection section that selects a shape of an image element appearing predetermined number of times or more in the input image, as a shape pattern;
a shape dictionary generation section that generates a shape dictionary including the shape pattern selected by the shape pattern selection section and second identification information identifying the shape pattern in association with each other;
a pattern extraction section that extracts the image element corresponding to the shape pattern from the input image with using the shape dictionary generated by the shape dictionary generation section; and
a shape code output section that outputs the second identification information of the shape pattern corresponding to the extracted image element and position information indicating an appearance position of the extracted image element as a part of code data of the image element extracted by the pattern extraction section.

3. The coding apparatus according to claim 1, wherein:
the density dictionary includes binary patterns corresponding to image densities and colors in association with the first identification information identifying the binary patterns; and
the density coding section selects the second identification information corresponding to the image density and color from the density dictionary, as the density information of the image element of each color component image making up the input image.

4. The coding apparatus according to claim 1, wherein:
the density coding section comprises:
a binary pattern selection section that selects a binary pattern appearing in the input image;
a density dictionary generation section that generates the density dictionary including the binary pattern selected by the binary pattern selection section and the first identification information identifying the binary pattern in association with each other; and
a density code output section that outputs the first identification information of the binary pattern corresponding to the image density and position information of the image density as code data corresponding to the density information contained in the input image with using the density dictionary generated by the density dictionary generation section.

5. A coding apparatus comprising:
a shape coding section that codes shape information of an image element contained in an input image with using a shape dictionary including a shape pattern indicating a typical shape contained in the input image and identification information identifying the shape pattern in association with each other; and
a density coding section that codes density information of the image element contained in the input image.

6. A coding apparatus comprising:
a shape coding section that codes shape information of an image element contained in an input image; and
a pattern coding section that codes pattern information of the image element contained in the input image with using a pattern dictionary including a binary pattern representing a pattern of the image element and identification information identifying the binary pattern in association with each other.

7. A decoding apparatus comprising:
a shape decoding section that decodes shape information of an image element contained in an input image based on code data;
a binary pattern selection section that selects a binary pattern corresponding to an image density of the image element with using a density dictionary including a binary pattern representing the image density and identification information identifying the binary pattern in association with each other; and
a data generation section that generates image data of the image element contained in the input image with using the shape information provided by the shape decoding section and the binary pattern selected by the binary pattern selection section.

8. A decoding apparatus comprising:
a shape pattern selection section that selects a shape pattern corresponding to an image element contained in an input image with using a shape dictionary including a shape pattern indicating a typical shape contained in the input image and identification information identifying the shape pattern in association with each other;
a density decoding section that decodes density information of the image element contained in the input image based on code data; and
a data generation section that generates image data of the image element contained in the input image with using the shape pattern selected by the shape pattern selection section and the density information provided by the density decoding section.

9. A decoding apparatus comprising:
a shape decoding section that decodes shape information of an image element contained in an input image based on code data;
a binary pattern selection section that selects a binary pattern corresponding to a pattern of the image element with using a pattern dictionary including a binary pattern representing a pattern of image element and identification information identifying the binary pattern in association with each other; and
a data generation section that generates image data of the image element contained in the input image with using the shape information provided by the shape decoding section and the binary pattern selected by the binary pattern selection section.

10. A data file comprising:
a density dictionary in which binary patterns representing image density and identification information identifying the binary patterns are registered in association with each other;
the identification information of the binary pattern corresponding to an image density of an image element contained in an input image;
position information indicating an appearance position of the image element; and
shape information indicating a shape of the image element.

11. A data file comprising:
a pattern dictionary in which binary patterns representing patterns and identification information identifying the binary patterns are registered in association with each other;
the identification information of the binary pattern corresponding to a pattern of an image element contained in an input image;
position information indicating a appearance position of the image element; and
shape information indicating a shape of the image element.

12. A coding method comprising:
coding shape information of an image element contained in an input image; and
coding density information of the image element contained in the input image with using a density dictionary including a binary pattern representing an image density and identification information identifying the binary pattern in association with each other.

13. A decoding method comprising:
decoding shape information of an image element contained in an input image based on code data;
selecting a binary pattern corresponding to the code data from a density dictionary including a binary pattern representing an image density and identification information identifying the binary pattern in association with each other; and
generating image data of the image element contained in the input image with using the provided shape information and the selected binary pattern.
